(19) United States
(12) Patent Application Publication
(10) Pub. No.: US 2026/0079388 A1
(43) Pub. Date: Mar. 19, 2026

(54) PROJECTION DEVICE SCREEN AND PROJECTION SYSTEM

(71) Applicant: SEIKO EPSON CORPORATION, Tokyo (JP)

(72) Inventor: Hirotaka KAWATA, SUWA-SHI (JP)

(21) Appl. No.: 19/325,684

(22) Filed: Sep. 11, 2025

(30) Foreign Application Priority Data
Sep. 13, 2024 (JP) 2024-159009

(51) Int. Cl. G03B 21/62; G02B 5/00; G02B 5/02

(52) U.S. Cl. CPC G03B 21/62; G02B 5/003; G02B 5/0242

(57) ABSTRACT

A projection device screen according to an aspect of the present disclosure is a projection device screen that emits projection light including first light in a first wavelength band and second light in a second wavelength band different from the first wavelength band, the projection device screen including a wavelength selection layer including a base material having translucency and a plurality of pieces of colloidal amorphous material dispersed in the base material. The plurality of pieces of colloidal amorphous material include a first colloidal amorphous material assuming a first structural color corresponding to the first wavelength band and a second colloidal amorphous material assuming a second structural color corresponding to the second wavelength band.

The present application is based on, and claims priority from JP Application Serial Number 2024-159009, filed September 13, 2024, the disclosure of which is hereby incorporated by reference herein in its entirety.

### BACKGROUND

### 1. Technical Field

The present disclosure relates to a projection device screen and a projection system.

### 2. Related Art

There has been known a reflective screen that reflects projection light emitted from a projection device and displays an image on an observation side. As the reflective screen of this type, there is known a technique of selectively reflecting only light having a specific wavelength corresponding to projection light emitted from a projector to remove external light noise and increase the contrast of a projection image. JP-A-2003-330119 described below discloses a screen in which a red reflective fine particle layer, a green reflective fine particle layer, and a blue reflective fine particle layer in which a plurality of fine particles are regularly arrayed are stacked on a substrate.

JP-A-2003-330119 is an example of the related art.

In the screen disclosed in JP-A-2003-330119, the fine particle layers have a structure in which, since the plurality of fine particles are regularly arrayed, a refractive index periodically changes in the wavelength order of light. A material having a structure of this type expresses a property of reflecting light having a specific wavelength with Bragg reflection. Accordingly, the light having the specific wavelength reflected by the fine particle layers is observed as a structural color. However, there is a problem in that a viewing angle of the structural color caused to express by the Bragg reflection is narrow and variation in contrast and tint is easily caused by a visual angle.

### SUMMARY

According to an aspect of the present disclosure, there is provided a projection device screen that emits projection light including first light in a first wavelength band and second light in a second wavelength band different from the first wavelength band, the projection device screen including a wavelength selection layer including a base material having translucency and a plurality of pieces of colloidal amorphous material dispersed in the base material. The plurality of pieces of colloidal amorphous material include a first colloidal amorphous material assuming a first structural color corresponding to the first wavelength band and a second colloidal amorphous material assuming a second structural color corresponding to the second wavelength band.

According to an aspect of the present disclosure, there is provided a projection system including: the projection device screen according to the aspect of the present disclosure explained above, and a projection device configured to emit the projection light toward the projection device screen.

### BRIEF DESCRIPTION OF THE DRAWINGS

FIG. 1 is a schematic configuration diagram of a projection system in a first embodiment.

FIG. 2 is a cross-sectional view of the screen taken along line II-II in FIG. 1.

FIG. 3 is a schematic view illustrating a part of a colloidal amorphous material.

FIG. 4 is a diagram illustrating the principle of Bragg reflection in a colloidal crystal.

FIG. 5 is a cross-sectional view of a screen in a second embodiment.

FIG. 6 is a cross-sectional view of a screen in a third embodiment.

FIG. 7 is a cross-sectional view of a screen in a fourth embodiment.

FIG. 8 is a cross-sectional view of a screen in a fifth embodiment.

FIG. 9 is a cross-sectional view of a screen in a sixth embodiment.

### DESCRIPTION OF EMBODIMENTS

### First Embodiment

A first embodiment of the present disclosure is explained below with reference to the drawings.

In the drawings referred to below, elements are sometimes drawn at different dimensional scales for clarity of the elements.

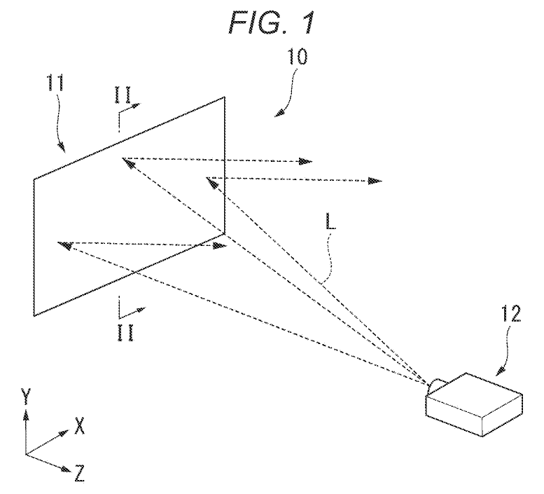

FIG. 1 is a schematic configuration diagram of a projection system 10 in the present embodiment.

As illustrated in FIG. 1, a projection system 10 according to the present embodiment includes a projection device screen 11 and a projection device 12. Hereinafter, the projection device screen 11 is simply referred to as screen 11. The projection device 12 emits projection light L toward the screen 11. The screen 11 reflects the projection light L emitted from the projection device 12 to display an image on an observation side. In the following explanation, an axis extending in the horizontal direction of the screen 11 is represented as an X axis, an axis extending in the vertical direction of the screen 11 is represented as a Y axis, and an axis extending in the front direction of the screen 11 is represented as a Z axis. That is, when viewed from an observer, the left-right direction corresponds to an X-axis direction, the up-down direction corresponds to a Y-axis direction, and the depth direction corresponds to ae Z-axis direction.

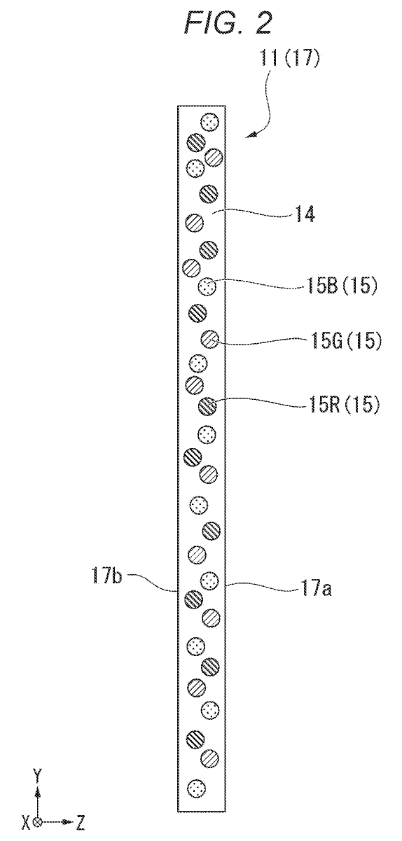

FIG. 2 is a cross-sectional view of the screen 11 taken along line II-II in FIG. 1.

As illustrated in FIG. 2, the screen 11 includes a wavelength selection layer 17 including a base material 14 having translucency and a plurality of pieces of colloidal amorphous material 15 dispersed in the base material 14. In the present embodiment, the wavelength selection layer 17 is a film-shaped member having translucency. The thickness of the wavelength selection layer 17 is, for example, approximately 50 μm to 20 mm. In the present specification, of two surfaces of the wavelength selection layer 17, the surface on the observation side is referred to as first surface 17a and the surface on the side opposite to the observation side is referred to as second surface 17b.

The plurality of pieces of colloidal amorphous material 15 include a plurality of pieces of first colloidal amorphous material 15B, a plurality of pieces of second colloidal amorphous material 15G, and a plurality of pieces of third colloidal amorphous material 15R. The plurality of pieces of first colloidal amorphous material 15B, the plurality of pieces of second colloidal amorphous material 15G, and the plurality of pieces of third colloidal amorphous material 15R are present in a state of being substantially uniformly dispersed on the inside of the base material 14.

Here, the colloidal amorphous material 15 is explained.

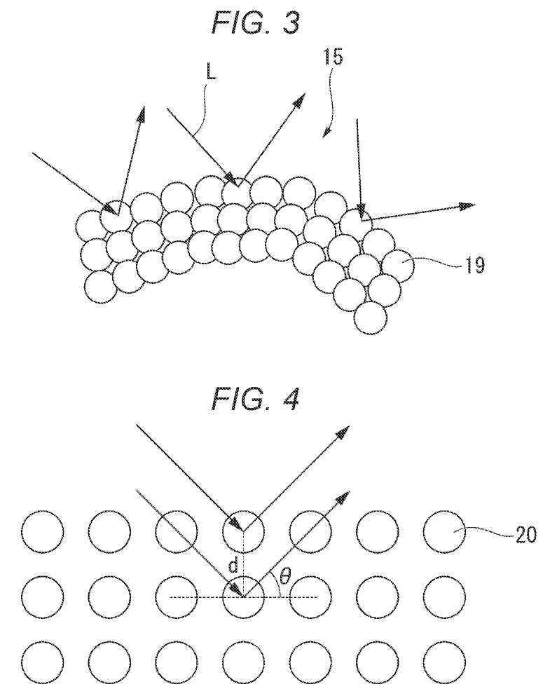

FIG. 3 is a schematic diagram illustrating an extracted part of the colloidal amorphous material 15. FIG. 4 is a diagram illustrating the principle of Bragg reflection in a colloidal crystal.

In general, particles having a particle size in a nano-size region are called colloidal particles. As illustrated in FIG. 4, an aggregate in which colloidal particles 20 having a uniform particle size are periodically arrayed is called colloidal crystal. In many cases, the colloidal crystal has a cycle in the same degree as the wavelength of visible light and selectively reflects light of a specific wavelength in a visible region corresponding to the cycle.

In contrast, as illustrated in FIG. 3, an amorphous or microcrystalline aggregate in which a plurality of particles 19 are regularly arrayed in all directions in a plane parallel to any reference plane, for example, the first surface 17a of the wavelength selection layer 17 in the present embodiment and a cycle of regularly arrayed units does not exceed the number of particles 20 is referred to as colloidal amorphous material 15. Therefore, in the colloidal amorphous material 15, the regular array of the particles 19 does not have a long distance order but has a short distance order. A lattice plane of the colloidal amorphous material 15 faces all directions. The structure of the colloidal amorphous material 15 of this type can be checked by observing a plane parallel to the reference plane with a scanning electron microscope.

In the case of the present embodiment, examples of a specific material of the particles 19 configuring the colloidal amorphous material 15 include silica particles. The refractive index of the silica particles is approximately 1.45. Besides, as an organic material, polystyrene particles, polymethyl methacrylate particles, and the like can be used. The refractive index of the polystyrene particles is approximately 1.6. The refractive index of the polymethyl methacrylate particles is approximately 1.49. Besides, polyimide resin, polyacrylic resin, methacrylic acid ester and a derivative thereof, epoxy resin, polycarbonate resin, polyamide resin, polyurethane resin, or the like may be used. It is desirable that the particle size of the particles 19 is, for example, approximately 100 to 500 nm and variation in a particle size is ± 20 nm or less. The entire shape of the colloidal amorphous material 15 in which the plurality of particles 19 are aggregated is substantially spherical and the particle size of the colloidal amorphous material 15 is, for example, approximately 10 to 100 μm. The content of the colloidal amorphous material 15 in the wavelength selection layer 17 is an amount of a degree occupying 10% or more of the entire area of the wavelength selection layer 17 when the wavelength selection layer 17 is viewed from the normal direction.

The particle sizes of the plurality of particles 19 configuring the first colloidal amorphous material 15B are substantially the same. The particle sizes of the plurality of particles 19 configuring the second colloidal amorphous material 15G are substantially the same. The particle sizes of the plurality of particles 19 configuring the third colloidal amorphous material 15R are substantially the same. The particle size of the particles 19 configuring the first colloidal amorphous material 15B, the particle size of the particles 19 configuring the second colloidal amorphous material 15G, and the particle size of the particles 19 configuring the third colloidal amorphous material 15R are different from one another.

Specifically, the particle size of the particles 19 configuring the first colloidal amorphous material 15B is smaller than the particle size of the particles 19 configuring the second colloidal amorphous material 15G. The particle size of the particles 19 configuring the second colloidal amorphous material 15G is smaller than the particle size of the particles 19 configuring the third colloidal amorphous material 15R. That is, when the particle size of the particles 19 configuring the first colloidal amorphous material 15B is represented as d1, the particle size of the particles 19 configuring the second colloidal amorphous material 15G is represented as d2, and the particle size of the particles 19 configuring the third colloidal amorphous material 15R is represented as d3, d1<d2<d3. The particle size of the first colloidal amorphous material 15B, the particle size of the second colloidal amorphous material 15B, and the particle size of the third colloidal amorphous material 15R may be the same or may be different.

As explained above, since the particle sizes of the particles 19 configuring the three types of colloidal amorphous materials 15B, 15G, and 15R are different from one another, cycles of refractive index changes of the three types of colloidal amorphous material 15B, 15G, and 15R are different from one another. Accordingly, the wavelengths of light reflected by the three types of colloidal amorphous material 15B, 15G, and 15R are different from one another and the structural colors assumed by the three types of colloidal amorphous material 15B, 15G, and 15R are different from one another.

Specifically, the first colloidal amorphous material 15B assumes a blue structural color corresponding to the wavelength band of blue light included in the projection light L emitted from the projection device 12. The second colloidal amorphous material 15G assumes a green structural color corresponding to the wavelength band of green light included in the projection light L emitted from the projection device 12. The third colloidal amorphous material 15R assumes a red structural color corresponding to the wavelength band of red light included in the projection light L emitted from the projection device 12. The blue structural color corresponding to the blue wavelength band in the present embodiment corresponds to a first structural color corresponding to a first wavelength band in the claim. The green structural color corresponding to the green wavelength band in the present embodiment corresponds to a second structural color corresponding to a second wavelength band in the claim. The red structural color corresponding to the red wavelength band in the present embodiment corresponds to a third structural color corresponding to a third wavelength band in the claim.

The base material 14 is made of a resin material having translucency. Examples of the resin material include ethoxylated trimethylol propane triacrylate containing 1% by weight of 2-hydroxy-2-methylpropiophenone or 0.5% by weight of a phosphine oxide compound as a photoinitiator. Alternatively, a resin material such as polymethyl methacrylate can also be used. Besides, polyester resin, vinyl resin, polycarbonate resin, polystyrene resin, polyethylene terephthalate resin, polyethylene naphthalate resin, polyvinyl butyral resin, polyimide resin, polystyrene resin, and the like may be used.

The refractive index of the colloidal amorphous material 15 and the refractive index of the base material 14 are different from each other. The difference between the refractive index of the colloidal amorphous material 15 and the refractive index of the base material 14 is desirably relatively small and is desirably, for example, 0.01 or more and 0.1 or less. By setting the difference between the refractive index of the colloidal amorphous material 15 and the refractive index of the base material 14 to as small as the above value, the full width at half maximum (FWHM) of a reflection wavelength spectrum of the colloidal amorphous material 15 can be narrowed and the chroma of the structural color can be increased. When this effect is considered, the projection light L emitted from the projection device 12 is desirably light having a wavelength in a narrow band like laser light.

When manufacturing the screen 11 in the present embodiment, after preparing a liquid substance of the base material 14 containing the colloidal amorphous material 15, the liquid substance only has to be molded into a film shape using, for example, an extrusion molding method, a solution casting method, various coating methods, or the like, and cured.

### Effects of the first embodiment

The screen 11 in the present embodiment is the projection device screen that emits the projection light L including the blue light, the green light, and the red light, the projection device screen including the wavelength selection layer 17 including the base material 14 having translucency and the plurality of pieces of colloidal amorphous material 15 dispersed in the base material 14. The plurality of pieces of colloidal amorphous material 15 include the first colloidal amorphous material 15B assuming the blue structural color corresponding to the blue light included in the projection light L, the second colloidal amorphous material 15G assuming the green structural color corresponding to the green light included in the projection light L, and the third colloidal amorphous material 15R assuming the red structural color corresponding to red light included in the projection light L.

As explained above, JP-A-2003-330119 discloses the screen in which the colloidal crystal that selectively reflects the light having the specific wavelength is used. However, in a general colloidal crystal, as illustrated in FIG. 4, a plurality of particles are regularly arrayed with a cycle of approximately the wavelength of light. The colloidal crystal of this type assumes a property of selectively reflecting light having a specific wavelength with Bragg reflection. When a cycle of a lattice plane in the colloidal crystal is represented as d, the wavelength of light is represented as λ, a mode refractive index is represented as n, and a glancing angle (a supplementary angle of an incident angle) of light is represented as θ, the Bragg condition described in JP-A-2003-330119 is represented by the following expression λ = 2(d/m)(n²-sin² θ)^{1/2} (m: integer))

When this Bragg condition is satisfied, interference of reflected lights strengthening each other occurs and strong reflected light is observed in a specific direction. Conversely, when the Bragg condition is not satisfied, strong reflected light is not observed. As explained above, there is a problem in that a viewing angle of a structural color expressed by the Bragg reflection is narrow and variation in contrast and tint easily occurs depending on a visual angle.

To solve this problem, with the screen 11 in the present embodiment, the wavelength selection layer 17 includes the first colloidal amorphous material 15B, the second colloidal amorphous material 15G, and the third colloidal amorphous material 15R and, as illustrated in FIG. 3, the lattice plane faces a different direction for each unit in which the plurality of particles 19 are regularly arrayed and, when the colloidal amorphous material 15 is viewed as a whole, the lattice plane faces all directions. For that reason, the Bragg condition explained above is satisfied for the projection light L made incident from various directions and the three types of colloidal amorphous materials 15B, 15G, and 15R can reflect light having a specific wavelength in all directions. As explained above, since the viewing angle of the structural color expressed by the colloidal amorphous material 15 is wide, it is possible to implement the screen 11 in which variation in contrast and tint due to a visual angle less easily occurs.

In the screen 11 in the present embodiment, the wavelength selection layer 17 includes the base material 14 in one layer in which the first colloidal amorphous material 15B, the second colloidal amorphous material 15G, and the third colloidal amorphous material 15R are dispersed. With this configuration, unlike when the wavelength selection layer includes a plurality of layers, since an interface of the base material 14 is absent on the inside of the wavelength selection layer 17, it is possible to implement the screen 11 with a less light loss and high light use efficiency.

The projection system 10 according to the present embodiment includes the screen 11 according to the present embodiment and the projection device 12 that emits the projection light L toward the screen 11.

With this configuration, it is possible to provide the projection system 10 excellent in display quality.

### Second Embodiment

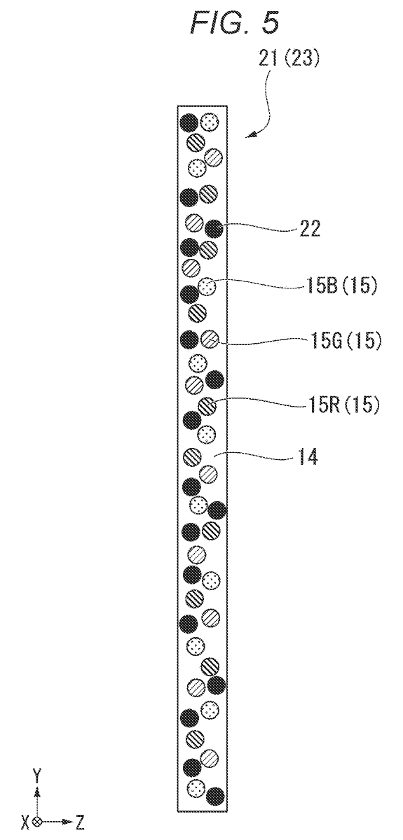

A second embodiment of the present disclosure is explained below with reference to FIG. 5.

Since a basic configuration of a screen in the present embodiment is the same as the basic configuration in the first embodiment, explanation about the common portions is omitted.

FIG. 5 is a cross-sectional view of a screen 21 according to the second embodiment.

In FIG. 5, elements common to those in the drawings referred to in the first embodiment are denoted by the same reference numerals and signs.

As illustrated in FIG. 5, the screen 21 in the present embodiment includes a wavelength selection layer 23 including the base material 14, the plurality of pieces of colloidal amorphous material 15, and a plurality of light absorbing particles 22. The plurality of pieces of colloidal amorphous material 15 and the plurality of light absorbing particles 22 are dispersed in the base material 14.

The light absorbing particles 22 absorb light in wavelength bands other than the wavelength band of blue light, the wavelength band of green light, and the wavelength band of red light included in the projection light L. Examples of a specific material of the light absorbing particles 22 include carbon, polydopamine, and polymer particles colored in black. The content of the light absorbing particles 22 is desirably approximately 0.2 to 2% by weight with respect to the base material 14.

### Effects of the second embodiment

In the present embodiment as well, since the wavelength selection layer 23 includes the colloidal amorphous material 15, it is possible to obtain the same effect as the effect in the first embodiment that it is possible to implement the screen 21 in which variation in contrast and tint due to a visual angle less easily occurs.

Further, in the screen 21 in the present embodiment, since the wavelength selection layer 23 includes the light absorbing particles 22, light other than the projection light L emitted from the projection device 12, specifically, external light unnecessary for display is absorbed by the light absorbing particles 22. Accordingly, the contrast of a projection image can be increased.

### Third Embodiment

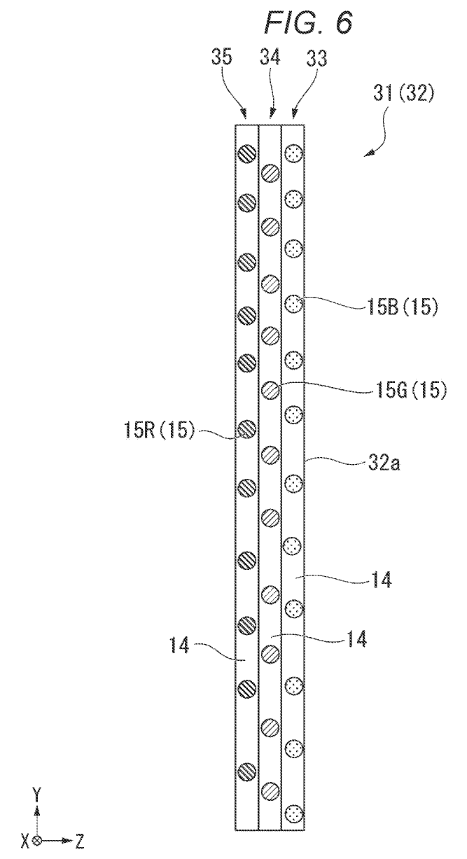

A third embodiment of the present disclosure is explained below with reference to FIG. 6.

Since a basic configuration of a screen in the present embodiment is the same as the basic configuration in the first embodiment, explanation about the common portions is omitted.

FIG. 6 is a cross-sectional view of a screen 31 in the third embodiment.

In FIG. 6, elements common to the elements in the drawings referred to in the first embodiment are denoted by the same reference numerals and signs.

As illustrated in FIG. 6, a screen 31 in the present embodiment includes a wavelength selection layer 32 including the base material 14 and the plurality of pieces of colloidal amorphous material 15. The wavelength selection layer 32 includes a first layer 33, a second layer 34, and a third layer 35. The first layer 33 is a layer in which the plurality of pieces of first colloidal amorphous material 15B are dispersed in the base material 14 and selectively reflects blue light. The second layer 34 is a layer in which the plurality of pieces of second colloidal amorphous material 15G are dispersed in the base material 14 and selectively reflects green light. The third layer 35 is a layer in which the plurality of pieces of third colloidal amorphous material 15R are dispersed in the base material 14 and selectively reflects red light. That is, the wavelength selection layer 32 has a configuration in which the base materials 14 in three layers in which the colloidal amorphous materials 15B, 15G, and 15R of types different from one another are dispersed are stacked.

The three layers are disposed in the order of the first layer 33, the second layer 34, and the third layer 35 from a first surface 32a on an observation side of the wavelength selection layer 32. The base materials 14 configuring the first layer 33, the second layer 34, and the third layer 35 are desirably made of the same material but may be made of different materials. The three layers 33, 34, and 35 may be bonded to one another using an optical adhesive or may not be bonded to one another and may be supported by any support member.

### Effects of the third embodiment

In the present embodiment as well, since the wavelength selection layer 32 includes the colloidal amorphous material 15, it is possible to obtain the same effect as the effect in the first embodiment that it is possible to implement the screen 31 in which variation in contrast and tint due to a visual angle less easily occurs.

Further, in the case of the present embodiment, since the wavelength selection layer 32 in which the base materials 14 in the three layers in which the colloidal amorphous materials 15B, 15G, and 15R of the types different from one another are dispersed are stacked is used, the colloidal amorphous materials 15B, 15G, and 15R are easily uniformly dispersed in the layers 33, 34, and 35 and a manufacturing process for the wavelength selection layer 32 can be facilitated.

In the manufacturing process for the wavelength selection layer 32, very small impurities and air bubbles are sometimes mixed inside the base material 14. The projection light L is likely to be scattered by the impurities and the air bubbles. When this point is considered, since the blue light having a short wavelength among the three color lights is most easily scattered, the use efficiency of the projection light L can be increased in a configuration in which the first layer 33 that reflects the blue light that is most easily scattered is disposed on an observation side.

### Fourth Embodiment

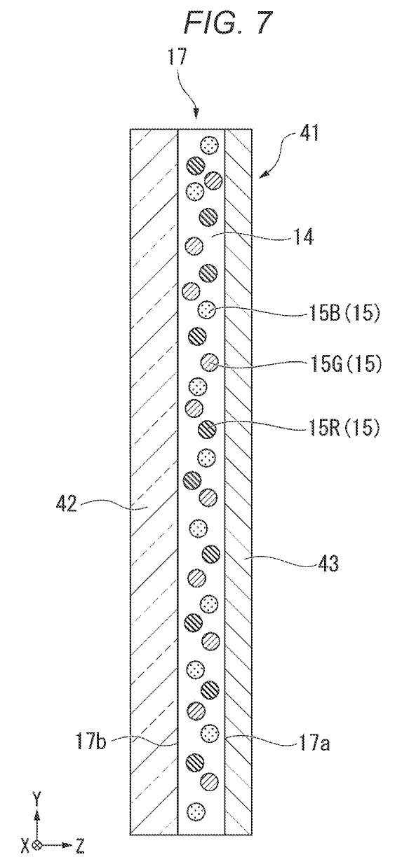

A fourth embodiment of the present disclosure is explained below with reference to FIG. 7.

Since a basic configuration of a screen in the present embodiment is the same as the basic configuration in the first embodiment, explanation about the common portions is omitted.

FIG. 7 is a cross-sectional view of a screen 41 in the fourth embodiment.

In FIG. 7, elements common to the elements in the drawings referred to in the first embodiment are denoted by the same reference numerals and signs.

As illustrated in FIG. 7, the screen 41 in the present embodiment includes the wavelength selection layer 17, a substrate 42, and an antireflection layer 43. The substrate 42 is provided on the second surface 17b of the wavelength selection layer 17. The antireflection layer 43 is provided on the first surface 17a of the wavelength selection layer 17. The wavelength selection layer 17 includes the base material 14 and the plurality of pieces of colloidal amorphous material 15 including the first colloidal amorphous material 15B, the second colloidal amorphous material 15G, and the third colloidal amorphous material 15R.

The wavelength selection layer 17 can also be replaced with the wavelength selection layer 23 in the second embodiment or the wavelength selection layer 32 in the third embodiment.

The substrate 42 may have translucency. For example, the substrate 42 is formed of a resin film of polyethylene terephthalate (PET) or the like having translucency, a glass substrate, or the like. The antireflection layer 43 is formed of, for example, a dielectric multilayer film. The transmittance of the screen 41 is desirably 50% or more and is more desirably 70% or more.

### Effects of the fourth embodiment

In the present embodiment as well, since the wavelength selection layer 17 includes the colloidal amorphous material 15, it is possible to obtain the same effect as the effect in the first embodiment that it is possible to implement the screen 41 in which variation in contrast and tint due to a visual angle less easily occurs.

According to the configuration in the present embodiment, since the screen 41 includes the substrate 42, the wavelength selection layer 17 can be supported by the substrate 42. Accordingly, the mechanical strength of the screen 41 increases and the screen 41 can be easily treated. Since the screen 41 includes the antireflection layer 43 on the first surface 17a of the wavelength selection layer 17, surface reflection of the screen 41 is suppressed and the visibility of a projection image can be improved.

### Fifth Embodiment

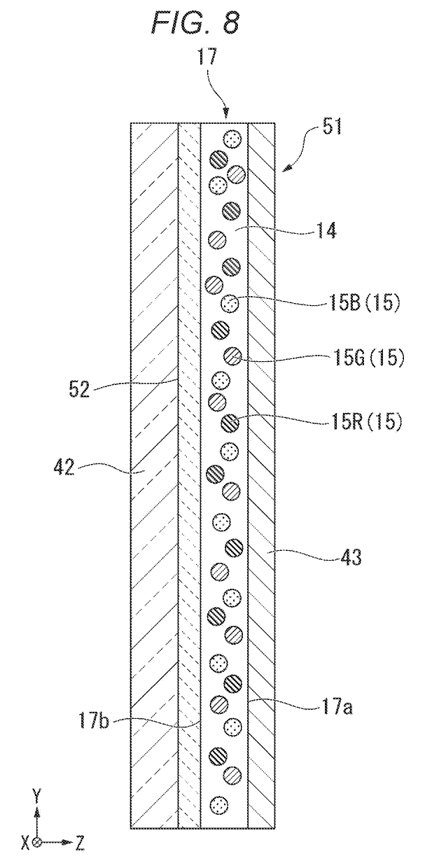

A fifth embodiment of the present disclosure is explained below with reference to FIG. 8.

Since a basic configuration of a screen in the present embodiment is the same as the basic configuration in the first embodiment, explanation about the common portions is omitted.

FIG. 8 is a cross-sectional view of a screen 51 in the fifth embodiment.

In FIG. 8, elements common to the elements in the drawings referred to in the embodiments explained above are denoted by the same reference numerals and signs.

As illustrated in FIG. 8, the screen 51 in the present embodiment includes the wavelength selection layer 17, the substrate 42, a light diffusion layer 52, and the antireflection layer 43. The light diffusion layer 52 is provided between the second surface 17b of the wavelength selection layer 17 and the substrate 42. The antireflection layer 43 is provided on the first surface 17a of the wavelength selection layer 17. The wavelength selection layer 17 includes the base material 14 and the plurality of pieces of colloidal amorphous material 15 including the first colloidal amorphous material 15B, the second colloidal amorphous material 15G, and the third colloidal amorphous material 15R.

The wavelength selection layer 17 can also be replaced with the wavelength selection layer 23 in the second embodiment or the wavelength selection layer 32 in the third embodiment.

The light diffusion layer 52 has, for example, a configuration in which a plurality of particles having a refractive index different from the refractive index of a transparent resin are dispersed in the transparent resin. Alternatively, the light diffusion layer 52 may be a layer having a fine uneven structure for scattering light. The light diffusion layer 52 is provided on the second surface 17b of the wavelength selection layer 17 and diffuses blue light, green light, and red light included in the projection light L. A half gain value of the screen 51 is desirably 45 degrees or more and is more desirably 60 degrees or more.

### Effects of the fifth embodiment

In the present embodiment as well, since the wavelength selection layer 17 includes the colloidal amorphous material 15, it is possible to obtain the same effect as the effect of the first embodiment that it is possible to implement the screen 51 in which variation in contrast and tint due to a visual angle less easily occurs.

With the configuration in the present embodiment, since the light diffusion layer 52 is provided on the second surface 17b of the wavelength selection layer 17, light reflected by the colloidal amorphous materials 15B, 15G, and 15R and traveling toward the second surface 17b of the wavelength selection layer 17 is diffused by the light diffusion layer 52 and emitted from the first surface 17a of the wavelength selection layer 17 to an observation side. Accordingly, it is possible to implement the screen 51 on which a bright image can be visually recognized over a wide visual angle.

### Sixth Embodiment

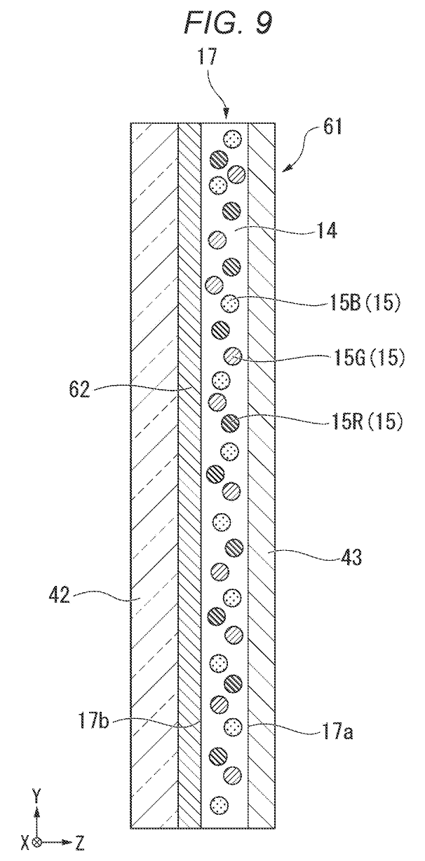

A sixth embodiment of the present disclosure is explained below with reference to FIG. 9.

Since a basic configuration of a screen in the present embodiment is the same as the basic configuration in the first embodiment, explanation about the common portions is omitted.

FIG. 9 is a cross-sectional view of a screen 61 in the sixth embodiment.

In FIG. 9, elements common to the elements in the drawings referred to in the embodiments explained above are denoted by the same reference numerals and signs.

As illustrated in FIG. 9, the screen 61 in the present embodiment includes the wavelength selection layer 17, the substrate 42, a light absorption layer 62, and the antireflection layer 43. The light absorption layer 62 is provided between the second surface 17b of the wavelength selection layer 17 and the substrate 42. The antireflection layer 43 is provided on the first surface 17a of the wavelength selection layer 17. The wavelength selection layer 17 includes the base material 14 and the plurality of pieces of colloidal amorphous material 15 including the first colloidal amorphous material 15B, the second colloidal amorphous material 15G, and the third colloidal amorphous material 15R.

The wavelength selection layer 17 can also be replaced with the wavelength selection layer 23 in the second embodiment or the wavelength selection layer 32 in the third embodiment.

The light absorption layer 62 is made of a material having a light absorption property such as carbon, polydopamine, or black resin. The light absorption layer 62 is provided on the second surface 17b of the wavelength selection layer 17 and desirably absorbs light in a wavelength band other than the blue light, the green light, and the red light included in the projection light L emitted from the projection device 12 but may be a material that absorbs all kinds of visible light. A half gain value of the screen 61 is desirably 45 degrees or more and is more desirably 60 degrees or more.

### Effects of the sixth embodiment

Also in the present embodiment, since the wavelength selection layer 17 includes the colloidal amorphous material 15, it is possible to obtain the same effect as the effect of the first embodiment that it is possible to implement the screen 61 in which variation in contrast and tint due to a visual angle less easily occurs.

With the configuration in the present embodiment, since the light absorption layer 62 is provided on the second surface 17b of the wavelength selection layer 17, unnecessary light such as external light transmitted through the wavelength selection layer 17 is absorbed by the light absorption layer 62. Accordingly, it is possible to provide the screen 61 on which an image with high contrast can be visually recognized.

Note that the technical scope of the present disclosure is not limited to the embodiments explained above, and various changes can be applied to the embodiment without departing from the gist of the present disclosure.

In the embodiments explained above, an example in which the wavelength selection layer includes the colloidal amorphous materials of the three types including the first colloidal amorphous material, the second colloidal amorphous material, and the third colloidal amorphous material is explained. However, instead of this configuration, the wavelength selection layer may include colloidal amorphous materials of at least two types.

In the third embodiment explained above, an example in which the wavelength selection layer includes the three layers is explained. However, instead of this configuration, the wavelength selection layer may include two layers. In this case, the wavelength selection layer only has to include a first layer including any two of the first colloidal amorphous material, the second colloidal amorphous material, and the third colloidal amorphous material and a second layer including the remaining one.

In the embodiments explained above, an example in which the screen is independent as one member and can be moved according to a place where the screen is used is explained. However, instead of this configuration, for example, the screen may be directly formed in a place where the screen is desired to be permanently installed, such as a wall surface of a conference room. In this case, a liquid substance of a base material containing a colloidal amorphous material only has to be applied to a desired position of the wall surface and cured. When the wall surface is a surface having a light diffusing property, as in the fifth embodiment, it is possible to implement a screen on which a bright image can be visually recognized. When the wall surface is a surface having a light absorbing property such as a black surface, as in the sixth embodiment, it is possible to implement a screen on which an image having high contrast can be visually recognized.

Besides, the specific description of the material, the composition, the disposition, and the like of the elements of the screen is not limited to the embodiments explained above and can be changed as appropriate. Layers other than the layers explained above may be interposed among the layers configuring the screen. The above explanation is based on the premise that the screen of the present disclosure is applied to a reflective screen. However, the screen of the present disclosure may be applied to a transmissive screen.

### Summary of the present disclosure

A summary of the present disclosure is appended below.

Appendix 1

A projection device screen that emits projection light including first light in a first wavelength band and second light in a second wavelength band different from the first wavelength band,

the projection device screen including a wavelength selection layer including a base material having translucency and a plurality of pieces of colloidal amorphous material dispersed in the base material, wherein

the plurality of pieces of colloidal amorphous material include a first colloidal amorphous material assuming a first structural color corresponding to the first wavelength band and a second colloidal amorphous material assuming a second structural color corresponding to the second wavelength band.

With the configuration of Appendix 1, since the wavelength selection layer has a plurality of pieces of colloidal amorphous material including the first colloidal amorphous material and the second colloidal amorphous material, it is possible to implement a screen in which variation in contrast and tint due to a visual angles less easily occurs.

Appendix 2

The projection device screen described in Appendix 1, wherein

the projection light further includes third light in a third wavelength band different from the first wavelength band and the second wavelength band,

the plurality of pieces of colloidal amorphous material further include a third colloidal amorphous material assuming a third structural color corresponding to the third wavelength band, and

the first structural color is blue, the second structural color is green, and the third structural color is red.

With the configuration of Appendix 2, it is possible to provide a screen corresponding to a projection device that projects a full color image.

Appendix 3

The projection device screen described in Appendix 2, wherein the wavelength selection layer further includes light absorbing particles that absorbs light in a wavelength band other than the first wavelength band, the second wavelength band, and the third wavelength band.

With the configuration of Appendix 3, since the wavelength selection layer includes the light absorbing particles, light other than the projection light emitted from the projection device, for example, unnecessary light such as external light is absorbed by the light absorbing particles, and the contrast of an image can be increased.

Appendix 4

The projection device screen described in Appendix 2 or 3, wherein the wavelength selection layer is formed of the base material in one layer in which the first colloidal amorphous material, the second colloidal amorphous material, and the third colloidal amorphous material are dispersed.

With the configuration of Appendix 4, unlike when the wavelength selection layer includes a plurality of layers, since an interface of the base material is absent on the inside of the wavelength selection layer, it is possible to implement a screen with a less light loss and high light use efficiency.

Appendix 5

The projection device screen described in Appendix 2 or 3, wherein the wavelength selection layer includes a first layer in which the first colloidal amorphous material is dispersed in the base material, a second layer in which the second colloidal amorphous material is dispersed in the base material, and a third layer in which the third colloidal amorphous material is dispersed in the base material.

With the configuration of Appendix 5, it is easy to uniformly disperse the plurality of pieces of colloidal amorphous material in each of the first layer, the second layer, and the third layer, and it is possible to facilitate a manufacturing process for the wavelength selection layer.

Appendix 6

The projection device screen described in Appendix 5, wherein, when a surface on an observation side of the wavelength selection layer is represented as a first surface, the first layer, the second layer, and the third layer are disposed in this order from the first surface.

With the configuration of Appendix 6, when very small impurities and air bubbles are mixed in the base material of the wavelength selection layer, since blue light is most easily scattered by the impurities and the air bubbles, if the first layer that reflects the blue light is disposed on the observation side, light use efficiency can be increased.

Appendix 7

The projection device screen described in any one of Appendices 2 to 6, wherein, when a surface on an observation side of the wavelength selection layer is represented as a first surface, the projection device screen includes an antireflection film on the observation side of the first surface.

With the configuration of Appendix 7, since the screen includes the antireflection layer on the first surface of the wavelength selection layer, surface reflection of the screen is suppressed, and the visibility of a projection image can be enhanced.

Appendix 8

The projection device screen described in any one of Appendices 2 to 7, further including a light diffusion layer that is, when a surface on a side opposite to an observation side of the wavelength selection layer is represented as a second surface, provided on the second surface and diffuses the first light, the second light, and the third light.

With the configuration of Appendix 8, since the light diffusion layer is provided on the second surface of the wavelength selection layer, light reflected by the colloidal amorphous materials and traveling to the side of the second surface of the wavelength selection layer is diffused by the light diffusion layer. Accordingly, it is possible to implement a screen on which a bright image can be visually recognized over a wide visual angle.

Appendix 9

The projection device screen described in any one of Appendices 2 to 7, further including a light absorption layer that is, when a surface on a side opposite to an observation side of the wavelength selection layer is represented as a second surface, provided on the second surface and absorbs light in a wavelength band other than the first wavelength band, the second wavelength band, and the third wavelength band or all kinds of visible light.

With the configuration of Appendix 9, since the light absorption layer is provided on the second surface of the wavelength selection layer, unnecessary light such as external light transmitted through the wavelength selection layer is absorbed by the light absorption layer. Accordingly, it is possible to implement a screen on which an image with high contrast can be visually recognized.

Appendix 10

A projection system including:

the projection device screen described in any one of Appendices 1 to 9; and

a projection device that emits the projection light toward the projection device screen.

With the configuration of Appendix 10, it is possible to provide a projection system excellent in display quality.

What is claimed is:

1. A projection device screen that emits projection light including first light in a first wavelength band and second light in a second wavelength band different from the first wavelength band,
the projection device screen comprising a wavelength selection layer including a base material having translucency and a plurality of pieces of colloidal amorphous material dispersed in the base material, wherein
the plurality of pieces of colloidal amorphous material include a first colloidal amorphous material assuming a first structural color corresponding to the first wavelength band and a second colloidal amorphous material assuming a second structural color corresponding to the second wavelength band.

2. The projection device screen according to claim 1, wherein
the projection light further includes third light in a third wavelength band different from the first wavelength band and the second wavelength band,
the plurality of pieces of colloidal amorphous material further include a third colloidal amorphous material assuming a third structural color corresponding to the third wavelength band, and
the first structural color is blue, the second structural color is green, and the third structural color is red.

3. The projection device screen according to claim 2, wherein the wavelength selection layer further includes light absorbing particles that absorbs light in a wavelength band other than the first wavelength band, the second wavelength band, and the third wavelength band.

4. The projection device screen according to claim 2, wherein the wavelength selection layer is formed of the base material in one layer in which the first colloidal amorphous material, the second colloidal amorphous material, and the third colloidal amorphous material are dispersed.

5. The projection device screen according to claim 2, wherein the wavelength selection layer includes a first layer in which the first colloidal amorphous material is dispersed in the base material, a second layer in which the second colloidal amorphous material is dispersed in the base material, and a third layer in which the third colloidal amorphous material is dispersed in the base material.

6. The projection device screen according to claim 5, wherein, when a surface on an observation side of the wavelength selection layer is represented as a first surface, the first layer, the second layer, and the third layer are disposed in this order from the first surface.

7. The projection device screen according to claim 2, wherein, when a surface on an observation side of the wavelength selection layer is represented as a first surface, the projection device screen includes an antireflection film on the observation side of the first surface.

8. The projection device screen according to claim 2, further comprising a light diffusion layer that is, when a surface on a side opposite to an observation side of the wavelength selection layer is represented as a second surface, provided on the second surface and diffuses the first light, the second light, and the third light.

9. The projection device screen according to claim 2, further comprising a light absorption layer that is, when a surface on a side opposite to an observation side of the wavelength selection layer is represented as a second surface, provided on the second surface and absorbs light in a wavelength band other than the first wavelength band, the second wavelength band, and the third wavelength band or all kinds of visible light.

10. A projection system comprising:
the projection device screen according to claim 1; and
a projection device that emits the projection light toward the projection device screen.
